(19) United States
(12) Patent Application Publication
(10) Pub. No.: US 2003/0058458 A1
(43) Pub. Date: Mar. 27, 2003

(54) Image-processing for output on a proofing device

(75) Inventors: Michael Anthony Cardoso, Citrus Heights, CA (US); Christopher Chandler Van Duker, Sacramento, CA (US)

Correspondence Address: Mr. David C. Jenkins, Suite 250, 7920 Alta Sunrise Drive, Citrus Heights, CA, 95610, US

(73) Assignee: RIPit Computer Corporation, Citrus Heights, CA

(21) Appl. No.: 09/961,606

(22) Filed: Sep. 24, 2001

(51) Int. Cl. H04N 1/52; H04N 1/60

(52) U.S. Cl. 358/1.9; 358/534; 358/504; 358/536; 358/518

(57) ABSTRACT

A user-generated image is processed, using amplitude-modulated screening, into high-resolution, raster-fomat halftones. The halftones are subdivided into a plurality of segments whose size is determined by the original processed resolution, the resolution of the output device, the original image size, and the size of the media on the output device. These segments are processed into continuous-tone matrices which are combined and color-converted as required by the particular output device. When printed on the output device, the resulting image is a faithful reproduction of the user-generated image as it would appear after being printed on a press.

### BACKGROUND OF THE INVENTION

The present invention relates to printing processes and, more particularly, to image-processing for output on a proofing device, thereby inexpensively providing a sample of a printing job that accurately reflects the desired printed image.

In the printing industry, the job to be printed must be reviewed and approved by the customer prior to the expenditure of time and money to print the job. Printing a sample from the press is both too expensive and too time-consuming, so an alternative method must be utilized. To be useful, the material to be reviewed must closely resemble the final product from the printing press. Traditionally this has meant expensive, time-consuming processes to produce what is termed a match-print. This invention uses a much faster, lower cost process to provide an output that closely resembles the press product and with which the user can make an informed decision about the appearance.

To place an image onto a medium such as paper, it is necessary to represent a range of visual tonal values. Images which contain a range of tonal values are called continuous-tone. Many image reproduction techniques are not capable of creating a continuous-tone effect, an example being offset printing. In offset printing, ink is either carried to the medium, or it is not, and there is no way to vary the amount of ink deposited at a particular location on the medium. To provide a continuous-tone image then requires that a number of small areas be defined, any of which can hold ink or not. A visual tone is created by varying the number of small areas that hold ink.

Because the human eye acts as an integrator, the small areas are integrated into larger areas whose visual intensity varies with the ratio of areas that hold ink to those that do not. This method of producing an apparent continuous-tone image from a plurality of small areas, each defined to either hold ink or be devoid of ink, is called halftoning.

To produce images with multiple colors, a printing press must employ multiple colors of ink. To preserve its color, each ink must not touch another ink when applied to the medium. For each ink, a unique halftone is produced, whose areas are arranged at an angle with respect to the other halftones used to produce the image. These angles keep the ink-defining areas of each halftone from overlapping one another. Because of these angles, the inked areas on the printed medium show a repeating pattern called a rosette. Because these rosettes are small, the eye does not readily discern them, but they do affect the appearance of the image. Therefore, when producing a sample to be approved by the user, it is desirable for the sample to closely resemble the final printed image with rosettes.

It is the object of this invention to provide a sample of a printing job that accurately reflects the image as it would appear after being printed.

### SUMMARY OF THE INVENTION

An image defined by a page-description language is processed into a high-resolution raster format comprised of halftones of the color components of that image. This raster format is intended to be used with a high-resolution output device to generate plates for use on a printing press. Alternatively, halftones are produced by scanning an existing printed image with a device such as the Hewlett-Packard ScanJet 5200C.

Picture elements in these halftones are integrated to develop a gray-scale matrix which is compatible with the destination proofing device. The size of the picture element in the output image, which is determined by the resolution of the output device, and the size of the output media versus the size of the original image define an area in the halftone in which the ratio of the picture elements which are “ON” to those which are “OFF” determine a value of intensity. Each halftone is thus converted to a gray-scale continuous-tone matrix and these matrices are then combined and color-corrected as required by a particular proofing device. The corrected grayscale matrices are then screened into halftones compatible with the selected proofing device. These halftones are then sent with the required protocol to the proofing device.

### BRIEF DESCRIPTION OF THE DRAWINGS

FIG. 1 is a block diagram of a typical system using this proofing method.

FIG. 2 is a block diagram showing the flow of data through this proofing process.

FIG. 3 illustrates subdividing an input halftone into cells whose size is based on the original image size and the output-media size.

FIG. 4 illustrates a further subdivision of one of the above-described cells into pixels.

FIG. 5 illustrates the integration of active pixels in a subdivided cell to calculate the density and produce a grayscale.

FIG. 6 illustrates the color-correction/modification of the grayscale.

FIG. 7 illustrates the color splitter, which may split a corrected grayscale into a light and a dark grayscale for proofing devices which have light and dark tones for some of the inks.

FIG. 8 illustrates the screening of the corrected grayscale.

FIG. 9 illustrates the output-data selector, which selects the desired data to send to the device driver.

FIG. 10 illustrates the device driver which sends the selected data and any device-initialization data to the proofing device.

### DETAILED DESCRIPTION OF THE INVENTION

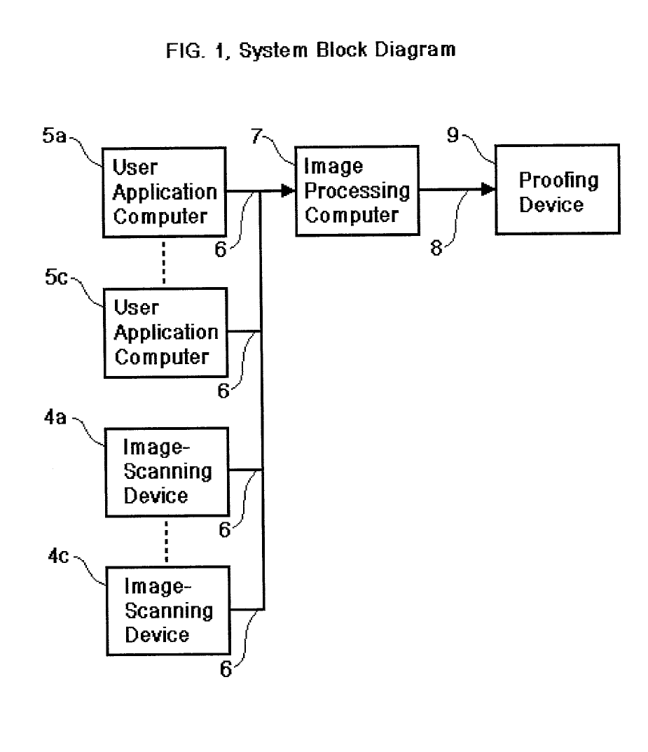

FIG. 1 shows a block diagram of a typical user installation which uses the proofing process according to the present invention. The user develops an image using the computer, 5a, which executes an application program that generates a description of the image. This image-description typically uses a page-description language such as ‘PostScript’ by Adobe Systems Incorporated. Such a page-description language describes how an image is to be created via commands to draw particular shapes and colors. In this manner, the description of the image is independent of a particular computer implementing the interpretation of the language. When the user has completed the image, the page description is sent to the computer executing the proofing process, 7, typically via a network connection, 6. This network may be local or distant. There may be more than one user connecting to the network and sending page-description files to the image-processing computer. Alternatively, the user-application may allow the user to directly edit a raster image without generating an intermediate page-description. As an additional alternative, an image-scanning device, 4a, may send image data to the image-processing computer, 7. The image-processing computer, 7, executes the proofing process and when the process is complete, sends the proofing data to the proofing device, 9, via a connection, 8. Such connection may be either a direct connection to the proofing device, 9, or a network connection. The proofing device, 9, such as the model “Stylus Color 5000” ink-jet printer by the Seiko Epson Corporaton, then generates the image on a medium suitable for review by the user. The medium is selected based on the type and coloration of ink used by the particular proofing device. In general, the medium is coated with material that holds the ink in place and prevents adjacent ink applications from running together, and is colored to combine with the ink in accurately reproducing coloration.

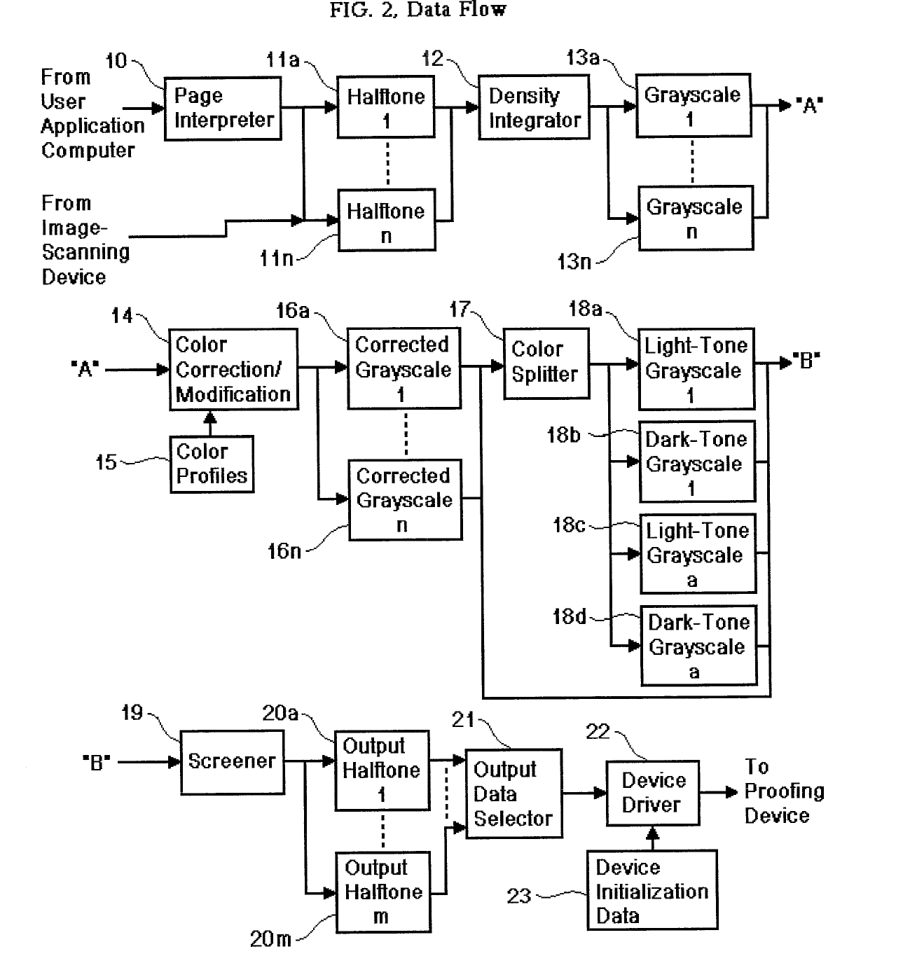

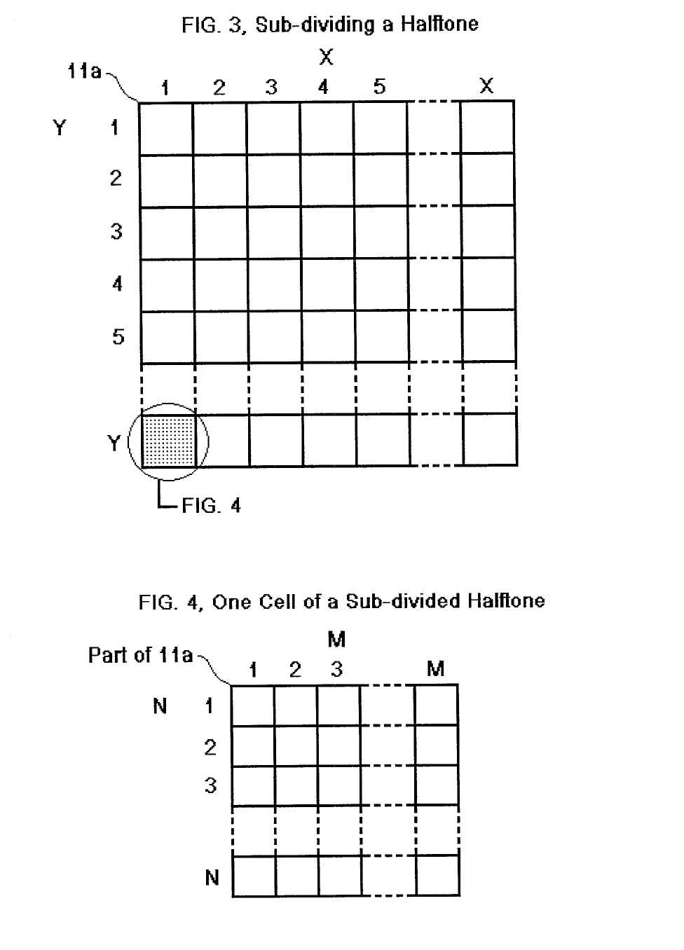

FIG. 2 shows a block diagram of the data-flow through this proofing process. The user computer provides an image in the form of a page-description language which is interpreted by a page-interpreter program, 10, such as the “PostScript Language Interpreter” by Adobe Systems Incorporated, whose output is binary halftones, 11a to 11n (‘n’ represents the number of halftones generated), typically one for each of the content of Cyan, Magenta, Yellow, and Black tone and any spot (special) color in the original image. Not all tones may be used, and other representations such as Red, Green and Blue could be used. Alternatively, an image-scanning device may provide halftones.

Each halftone produced by the page interpreter, 10, or image-scanning device, 4a, is processed by a density integrator, 12, to determine the percentage of color in the image, resulting in a continuous-tone matrix called a grayscale, 13a to 13n.

The halftones which are produced by the page-description interpreter at high resolution, with amplitude-modulated screening, are subdivided areally by the density integrator, 12. The scaling-factor which determines the size of each subdivision is based on the original image size times the original resolution, divided by the output size and output resolution:

SF=Xi*Ri/Xo*Ro.

where:

SF=scaling-factor

Xi is the original input size

Ri is the original input resolution

Xo is the output size

Ro is the output resolution

In the present implementation, the scaling factor is allowed to be equal to or greater than 1. Those skilled in the art can appreciate that a scaling factor less than one could also be used.

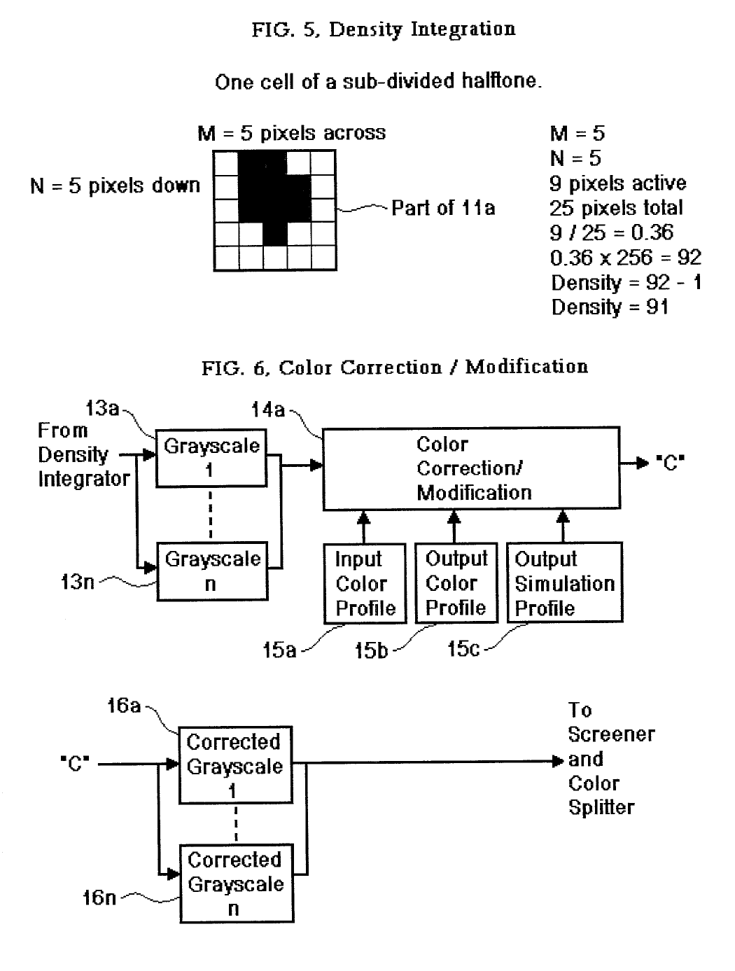

As an example, in FIG. 5, “Density Integration”, an original image which is 8.5 inches wide, 11 inches long, and 1,800 dots-per-inch resolution, is being subdivided into cells for output to a proofing device whose media size is 8.5 inches wide, 11 inches long, and whose resolution is 360 dots-per-inch.

The scaling-factor for the X-direction is:

Xi=8.5, Ri=1,800, Xo=8.5, Ro=360 then:

SFx=8.5*1,800/8.5*360

SFx=5

For the Y-direction, the scaling-factor is:

Yi=11, Ri=1,800, Yo=11, Ro=360 then:

SFy=11*1,800/11*360

SFy=5

Thus the halftone is subdivided into cells that are 5 pixels wide and 5 pixels high. It is to be appreciated by those skilled in the art that the scaling factors for the X and Y directions may be different without adversely affecting this method.

The scaling factors determine the cell size, which cell is repeated through the halftone to subdivide it.

For each cell thus formed, the density integrator sums the number of pixels in the cell that are “ON”, divides by the total number of pixels in the cell, multiplies that result by 256, then subtracts 1. This provides an eight-bit grayscale value which varies from 0 to 255.

Density=(256*Pixels-On/Total-pixels)−1.

For the cell illustrated in FIG. 5:

Total-pixels=5*5

Total-pixels=25

Pixels-On=9

Thus the calculated density is:

Density=(256*9/25)−1

Density=91

This process is repeated for each cell in the subdivided halftone. Each halftone produced by the page-interpreter is thus converted to a continuous-tone grayscale.

These continuous-tone grayscales produced by the density integrator, 12, are then color-corrected as shown in FIG. 6, “Color Correction/Modification”, using readily available software for the color correction/modification, 14. Typical software is ICM2.0, which is a component of the Microsoft Windows API (Application-Program-Interface). In this routine the input data are corrected into CIE (Commission Internationale De L'Eclarage, International Commission on Illumination) colors using an “Input Color Profile”, 15a. These normalized colors are then corrected for the characteristics of the output device using an “Output Color Profile”, 15b. If it is desired to simulate the characteristics of an output device, a “Simulation Color Profile”, 15c, can be utilized. These color profiles are developed using techniques and software readily vailable and known to those skilled in the art. The output from the color correction/modification are the corrected grayscales, 16a through 16n.

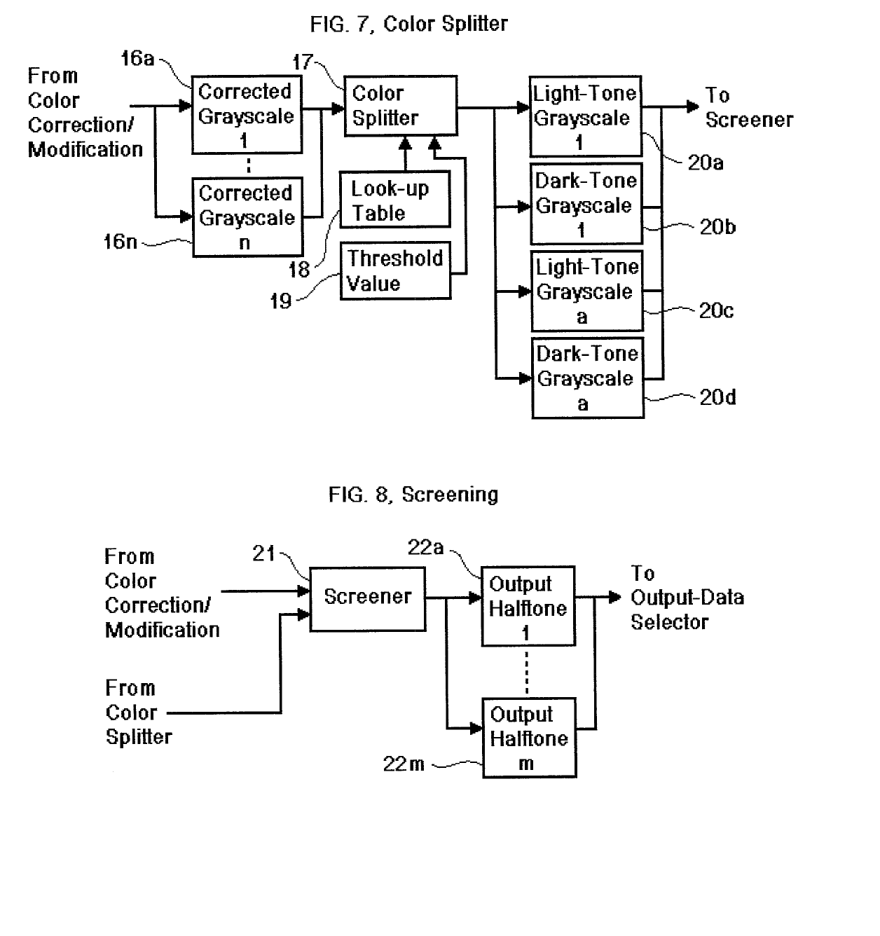

Because some proofing devices have both a light and a dark tone for some colors of ink to enhance the range of visual tonal values, one or more of the halftones output by the color correction module, 16a through 16n, may need to be split into a light and a dark tone. This is accomplished by the “Color Splitter” shown in FIG. 7. There are two techniques currently used to accomplish this. One technique is to set a threshold value, 19, to 128. All values in the grayscale that are less than this threshold are placed in the light-tone grayscale array, and all other values are placed into the dark-tone grayscale array. The values placed into the light-tone grayscale array are further manipulated by multiplying by 2 so that the range of values in the array is from 0 to 254:

Light-tone=value*2

Similarly, the values placed into the dark-tone grayscale array have the threshold value subtracted from their value, then multiplied by 2, again so that the range of values in the array is from 0 to 254:

Dark-tone=(value−128)*2

A second technique is to compare the original grayscale values with a look-up table to provide custom and variable tonal values. This table can be constructed by repetitively outputting test patterns and measuring the corresponding color values with a spectrophotometer such as the “SpectroScan” by GretagMacbeth, and adjusting the table values to minimize the error between the desired color and the device output. The output of the color splitter are the light- and dark-tone grayscales, 18a to 18d, where ‘d’ represents the total number of grayscales generated for tonal-range expansion. There will be a light- and a dark-tone grayscale for each color which is split.

The outputs from the color-correction module and the color-splitter are applied to the “Screener”, 21, shown in FIG. 8, “Screening”. Using an error-diffusion method (Disclosed in U.S. Pat. No. 5,917,614), this screening generates halftones with improved smoothness in both highlight and shadow regions of the image. In this method, the square of the distance to the nearest previously generated dot is used as a bias value to modulate the error-diffusion threshold. This results in a halftone with a more uniform texture. The output of the screener is contained in “Output Halftones” 22a through 22m (‘m’ is the number of halftones produced).

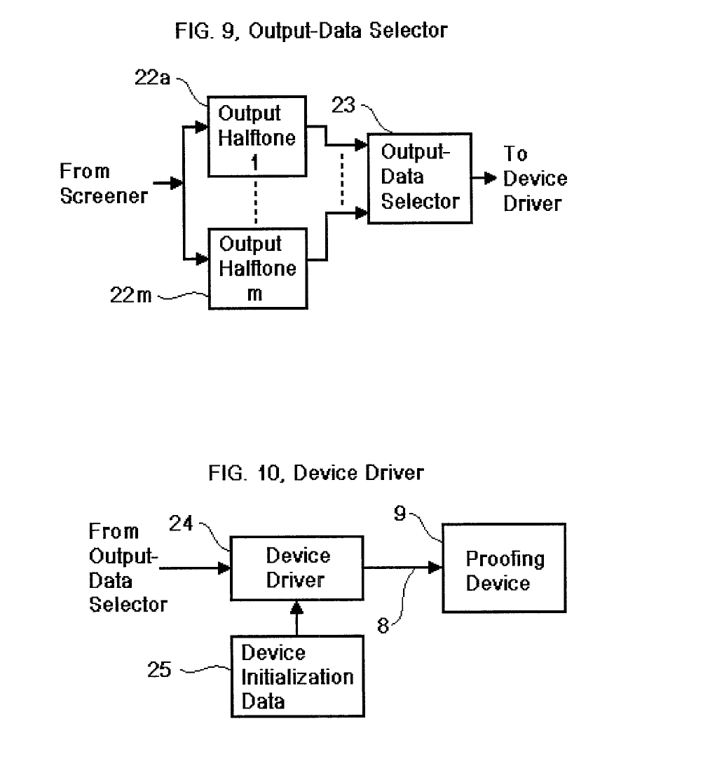

Depending on the proofing device characteristics, the “Output-Data Selector”, 23, in FIG. 9, selects the data from halftones 22a through 22m to be sent to the proofing device. The data may be sent one halftone at a time, or may be interleaved with alternating data from all the halftones. This data is sent according to the required transmission protocol which is coordinated by the “Device Driver”, 24, in FIG. 10. For each job, the proofing device is initialized with the “Device Initialization Data”, 25, which prepares the device for the desired performance.

What is claimed as new and desired to be secured by Letters Patent of the United States is:

1. A method of producing on an output device an output image that is scaled in size from the original and is a faithful reproduction of the user-generated image comprising:
a. inputting image halftone files, each representing the density of a unique color component of the image;
b. subdividing said halftones into a plurality of areal elements, within which a density value is calculated;
c. converting said adjusted values to binary halftones using a screening process; and
d. supplying said binary halftones to the output device.

2. The method defined in claim 1, wherein the image halftones are provided by a scanning process.

3. The method defined in claim 1, wherein the image halftones are provided by an alternative process.

4. The method defined in claim 1, wherein the image halftones are processed simultaneously with this process.

5. The method defined in claim 1, wherein the density values are adjusted for the characteristics of the output device.

6. The method defined in claim 1, wherein the density values are adjusted to provide different coloration than the original image.

7. The method defined in claim 1, wherein the output halftones form a rosette pattern when superimposed.
